(19) United States
(12) Patent Application Publication
(10) Pub. No.: US 2015/0154606 A1
(43) Pub. Date: Jun. 4, 2015

(54) SYSTEM, METHOD, AND SOFTWARE FOR ENTERPRISE-WIDE COMPLAINT AGGREGATION

(71) Applicant: Bank of America Corporation, Charlotte, NC (US)

(72) Inventors: Scott G. Miller, Edgewater, MD (US); Michael D. Alexanian, Kingston, MA (US); Michael D. Napolin, Middletown, DE (US); Steve Belsito, Charlotte, NC (US); Sandeep Vasudevan, San Antonio, TX (US); Janet A. MacDonald, Huntersville, NC (US)

(21) Appl. No.: 14/558,816

(22) Filed: Dec. 3, 2014

Related U.S. Application Data
(63) Continuation of application No. 13/570,755, filed on Aug. 9, 2012.

(51) Int. Cl. G06Q 30/00; G06F 17/30

(52) U.S. Cl. CPC G06Q 30/016; G06F 17/30525

(57) ABSTRACT

In certain embodiments, a method includes accessing (1) a first complaint record comprising data generated by a first system of record for an enterprise, and (2) a second complaint record comprising data generated by a second system of record for the enterprise, the second system of record operating independently from the first system of record. The method further includes determining an association between the first complaint record and the second complaint record by identifying common information from the first complaint record and the second complaint record. The method further includes storing, in association with one another, the first complaint record, the second complaint record, and the determined association between with the first complaint record and the second complaint record.

### RELATED APPLICATIONS

This application is a continuation of Ser. No. 13/570,755, entitled “SYSTEM, METHOD, AND SOFTWARE FOR ENTERPRISE-WIDE COMPLAINT,” Attorney's Docket 015444.0753, filed Aug. 9, 2012, currently pending.

### TECHNICAL FIELD OF THE INVENTION

This disclosure relates generally to customer service and more particularly to enterprise-wide complaint aggregation.

### BACKGROUND OF THE INVENTION

In certain industries, enterprises may include customer service departments that are charged with receiving and addressing complaints of customer of the enterprise. Certain large enterprises may include multiple customer service departments each dedicated to a particular segment of the enterprise. In these large enterprises, the various customer service departments may operate relatively independently of one another and may even rely on different systems of record when logging customer complaints. Accordingly, the customer service department of one segment of an enterprise may have little or no insight into the complaints received by the customer service department of another segment of the same enterprise.

### SUMMARY OF THE INVENTION

According to embodiments of the present disclosure, disadvantages and problems associated with previous systems for logging customer complaints may be reduced or eliminated.

In certain embodiments, a method includes accessing (1) a first complaint record comprising data generated by a first system of record for an enterprise, and (2) a second complaint record comprising data generated by a second system of record for the enterprise, the second system of record operating independently from the first system of record. The method further includes determining an association between the first complaint record and the second complaint record by identifying common information from the first complaint record and the second complaint record. The method further includes storing, in association with one another, the first complaint record, the second complaint record, and the determined association between with the first complaint record and the second complaint record.

Particular embodiments of the present disclosure may provide one or more technical advantages. For example, in certain embodiments of the present disclosure, complaint records generated by various systems of record within an enterprise may be associated with one another and stored as aggregated complaint records. In addition, the aggregated complaint records may include additional information related to the associated complaint records (e.g., additional information regarding a common complaining customer, additional information regarding individuals living at the same address as a common complaining customer, etc.). According, certain embodiments of the present invention may provide an enterprise-wide view of customer complaints, which may be beneficial in decided how (or in what order) to address those complaints.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

FIG. 1 illustrates an example system for providing enterprise-wide complaint aggregation, according to certain embodiments of the present disclosure; and

FIG. 2 illustrates an example method for providing enterprise-wide complaint aggregation, according to certain embodiments of the present disclosure.

### DETAILED DESCRIPTION OF THE INVENTION

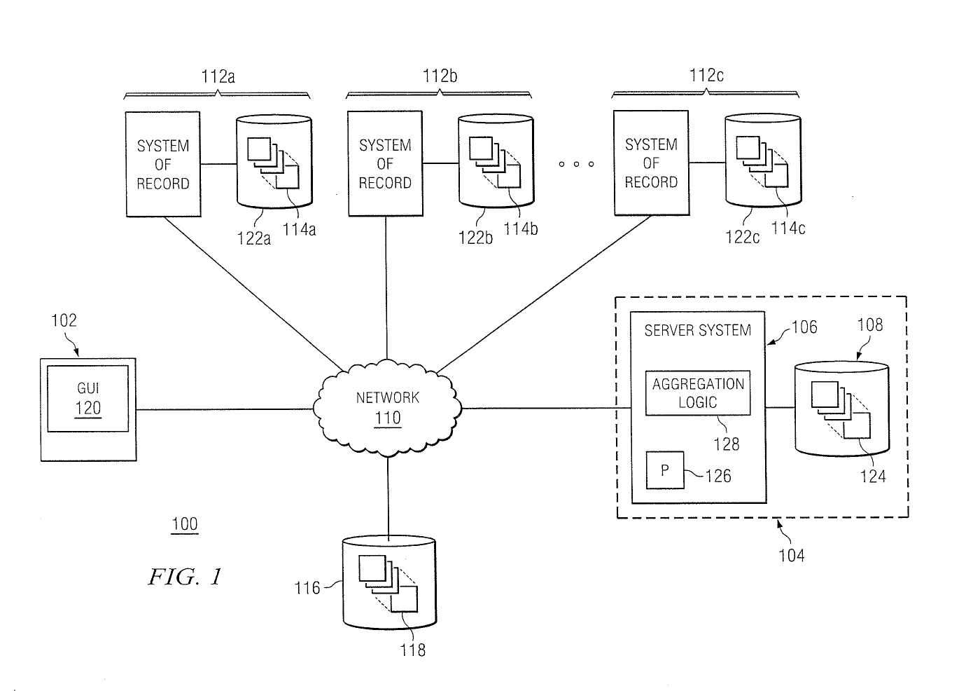

FIG. 1 illustrates an example system 100 for providing enterprise-wide complaint aggregation, according to certain embodiments of the present disclosure. System 100 may include a user system 102 and an aggregation system 104. Aggregation system 104 may include a server system 106 and a database 108. User system 102 may be configured to communicate with aggregation system 104 via a network 110. System 100 may additionally include (1) a plurality of systems of record 112 each of which may be used to generate complaint records 114 for a particular segment of an enterprise, and (2) a customer information database 116 storing customer information files 118 for customers of the enterprise. Although this particular implementation of system 100 is illustrated and primarily described, the present invention contemplates any suitable implementation of system 100 according to particular needs.

In general, system 100 is operable to provide aggregation of complaint records 114 across various business segments of an enterprise. For example, a large enterprise may include a number of business segments, and each business segment may have its own system of record 112 for logging complaints of for that business segment (i.e., generating complaint records 114). Moreover, each system of record 112 may be uniquely adapted to the business segment to which it corresponds; therefore, the complaint records 114 generated by different systems of record 112 may not have a common format. Although complaint records 114 may be useful within the system of record 114 by which they were generated, it may be desirable to associate complaint records 114 generated by different systems of record 112 (e.g., by identifying common information among the complaint records 114) in order to provide an enterprise-wide view of complaint records 114. As just one example, in order to determine how to respond to a particular complaint record 114 generated by a particular system of record 112, it may be desirable to view all associated complaint records 114 across the enterprise (e.g., complaint records 114 stemming from the same customer but generated by different systems of record 112) as well as additional information relevant to the aggregated complaint record (e.g., additional information about the customer).

User system 102 may include any suitable device or combination of devices operable to allow a user (e.g., an enterprise employee or other authorized personnel) to access all or a portion of the functionality associated with aggregation system 104 (as described in detail below). For example, user system 102 may include one or more computer systems at one or more locations. A computer system, as used herein, may include a personal computer, workstation, network computer, kiosk, wireless data port, personal data assistant (PDA), one or more processors within these or other devices, or any other suitable processing device. Additionally, each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media.

In certain embodiments, user system 102 may include a graphical user interface (GUI) 120, which may be delivered using an online portal, hypertext mark-up language (HTML) pages for display and data capture, or in any other suitable manner. GUI 120 may allow a user of user system 102 to interact with other components of system 100. For example, GUI 120 may allow a user of user system 102 to access all or a portion of the functionality associated with aggregation system 104 (as described in further detail below). Although a single user system 102 is depicted and described, the present disclosure contemplates that system 100 may include any suitable number of user systems 102, according to particular needs.

Systems of record 112 may each include any suitable device or combination of devices operable to facilitate the generation and/or storage of complaint records 114. Each system of record 112, which may include one or more computer systems at one or more locations, may include (or be communicatively coupled to) a database 122 for storing generated complaint records 114. Each database 122 may comprise any suitable memory module and may take the form of volatile or non-volatile memory, including, without limitation, magnetic media, optical media, random access memory (RAM), read-only memory (ROM), removable media, or any other suitable local or remote memory component.

In certain embodiments, each system of record 112 may be associated with a particular segment of an enterprise and may be operable to generate complaint records 114 associated with that segment of the enterprise. As one particular example, a banking enterprise may include several business segments (e.g., a checking account department, a credit card department, and a home mortgage department), and each one of these business segments may have an associated system of record 114 for logging customer complaints associated with the business segment (i.e., for generating complaint records 114).

Complaint records 114 generated by systems of record 112 may each include any suitable categories of information for documenting a received complaint. For example, a complaint record 114 may include the name of the complaining customer, an account number associated with the customer, the nature of the complaint (e.g., a complaint type), the time of the complaint, and any other suitable information relevant to the received complaint. Additionally, because each system of record may be uniquely configured based on the business segment with which it is associated, complaint records 114 generated by different systems of record 112 may not include identical formats/categories of information (as different categories of information may be relevant to different segment of an enterprise).

As one particular example, a banking enterprise may include a checking account department having an associated system of record 112a and a credit card department having a separate system of record 112b. System of record 112a, in response to customer complaints received by the checking account department, may generate complaint records 114a with categories of including (1) the name of the complaining customer, (2) the checking account number of the complaining customer, and (3) a complaint type as defined within the checking account department. Similarly, system of record 112b, in response to customer complaints received by the credit card department, may generate complaint records 114b with categories of information including (1) the name of the complaining customer, (2) the credit card number of the complaining customer, and (3) a complaint type as defined within the credit card department. Thus, although complaint records 114a and 114b may share a common category of information (e.g., the name of the complaining customer), they may not share a common template.

In certain embodiments, one or more systems of record 112 may generate complaint records 114 based on inputs received from a user associated with the system of record 112. For example, a system of record 112 may be associated with a customer service department of a particular segment of an enterprise, and a customer service representative receiving complaints via telephone may use the system of record 112 to generate complaint records 114 (e.g., by keying in relevant complaint information). In certain other embodiments, one or more systems of record 112 may generate complaint records 114 in an automated manner. For example, a system of record 112 may be configured to receive complaint information directly from customers (e.g., emails, online complaint forms, etc.), and, based on the received information, generate complaint records 114.

Although a particular number of systems of record 112 are depicted, the present disclosure contemplates any suitable number of systems of record 112, according to particular need. Additionally, although user system 102 and systems of record 112 are described as being separate, the present disclosure contemplates that the computer systems and the functionality associated with user system 102 and systems of record 112 may be combined or separated in any suitable manner. As one particular example, the present disclosure contemplates that all or a portion of the functionality described herein as being associated with user system 102 may additionally or alternatively be provided by each system of record 112.

User system 102 and systems of record 112 may each be communicatively coupled to aggregation system 104 via network 110. Network 110 may facilitate wireless or wireline communication and may communicate, for example, IP packets, Frame Relay frames, Asynchronous Transfer Mode (ATM) cells, voice, video, data, and other suitable information between network addresses. Network 114 may include one or more local area networks (LANs), radio access networks (RANs), metropolitan area networks (MANs), wide area networks (WANs), all or a portion of the global computer network known as the Internet, and/or any other communication system or systems at one or more locations.

Aggregation system 104 may include any suitable system operable to generate aggregated complaint records 124 based on complaint records 114 generated by the various systems of record 112 of system 100 (as described in further detail below). In certain embodiments, aggregation system 104 may include a server system 106 and a database 108. Server system 106 may include one or more electronic computing devices operable to receive, transmit, process, and store data associated with system 100. For example, server system 106 may include one or more general-purpose PCs, Macintoshes, workstations, Unix-based computers, server computers, one or more server pools, or any other suitable devices. In short, server system 106 may include any suitable combination of software, firmware, and hardware. Although a single server system 106 is illustrated, the present disclosure contemplates system 100 including any suitable number of server systems 106. Moreover, although referred to as a “server system,” the present disclosure contemplates server system 106 comprising any suitable type of processing device or devices.

Server system 110 may include one or more processing modules 126, each of which may include one or more microprocessors, controllers, or any other suitable computing devices or resources. Processing modules 126 may work, either alone or with other components of system 100, to provide a portion or all of the functionality of system 100 described herein. Server system 106 may additionally include (or be communicatively coupled to) a database 108. Database 108 may comprise any suitable memory module and may take the form of volatile or non-volatile memory, including, without limitation, magnetic media, optical media, RAM, ROM, removable media, or any other suitable local or remote memory component.

In certain embodiments, server system 110 may include aggregation logic 128. Aggregation logic 128 may include any suitable combination of hardware, firmware, and software operable to generate aggregated complaint records 124 based on determined associations between complaint records 114, as described in detail below. In certain embodiments, aggregation logic 128 may generate aggregated complaint records 124 is response to a request from a user of user system 102. In certain other embodiments, aggregation logic 128 may generate aggregated complaint records 124 automatically by periodically processing all or a portion of the complaint records 114 stored in databases 122 of systems of record 112.

In order to generate aggregated complaint records 124, aggregation logic 128 may be operable to access (via network 110) complaint records 114 stored in databases 122 of systems of record 112. By processing the categories of information contained in the accessed complaint records 114, aggregation logic 128 may determine associations among two or more of the accessed complaint records 114 (e.g., common information among the two or more complaint records 114).

For example, aggregation logic 128 may access (1) a first complaint record 114a generated by a system of record 112a associated with a checking account department of an enterprise, and (2) a second aggregation record 114b generated by a system of record 112b associated with a credit card account department of an enterprise. The accessed first complaint record 114a may have categories of information including (1) the name of the complaining customer, (2) the checking account number of the complaining customer, and (3) a complaint type as defined within the checking account department. The accessed second complaint record 114b may have categories of information including (1) the name of the complaining customer, (2) the credit card number of the complaining customer, and (3) a complaint type as defined within the credit card department. By processing the first complaint record 114a and the second complaint record 114b, aggregation application 128 may determine that the two complaint records 114 have a common category of information (i.e., the name of the complaining customer) and that the information contained in that category is the same (i.e., both complaint records 114 were generated in response to a complaint from the same customer). Based on this determined association, aggregation logic 128 may store the first complaint record 114a and the second complaint record 114b is association with one another as a aggregated complaint record 124 (e.g., in database 108).

In certain embodiments, aggregation logic 128 may be further operable to determine additional information to be stored as part of a generated aggregated complaint record 124. For example, aggregation logic 128 may be configured to communicate (e.g., via network 110) with a customer information database 116 storing customer information files 118. Customer information files 118 may each include information regarding a particular customer of an enterprise. For example, a particular customer information file 118 may include the name of a customer of the enterprise, a home address for the customer, a social security number for the customer, all account numbers for the customer across various segments of the enterprise, other individuals living at the same address of the customer, etc. Although customer information files 118 are depicted and described as being stored in a customer information database 116 that is separate from other components of system 100, the present disclosure contemplates that customer information files 118 may be stored at any suitable location within system 100.

Aggregation logic 128 may, based on the determined association between two or more complaint records 114 (e.g., the name of the complaining customer, as described above), access an appropriate customer information file(s) 118 (e.g., the customer information file 118 including the name of the complaining customer and/or a customer information file for another customer living at the same address as the complaining customer). Because the complaint records 114 of the aggregated complaint record 124 may only include partial information for the complaining customer, additional information regarding the customer (e.g., home address, social security number, accounts information for other customers living at the same address, etc) may be determined based on the customer information file 118 and stored as part of the aggregated complaint record 124.

In certain embodiments, aggregation logic 128 may be further operable to determine a complaint category for each of the complaint records 114 stored as part of an aggregated complaint record 124. For example, one or more of the associated complaint records 114 of an aggregated complaint category 124 may include a complaint type, which, as described above, may be specific to the segment of the enterprise for which the complaint record 114 was generated. Because an enterprise may have a number of different segments each having their own complaint types, it may be desirable to classify each of the complaint types into a broader complaint category. Accordingly, aggregation logic may classify each of the complaint records 114 of an aggregated complaint record into a complaint category (e.g., based on the complaint type of each of the complaint records 114).

Because aggregated complaint records 124 may associate complaint records 114 generated by different systems of record 112 across an enterprise, a user of user system 102 accessing aggregated complaint records 124 may be provided an enterprise-wide view of customer complaints. Such an enterprise-wide view may be beneficial in determining how to address particular complaints. For example, if aggregated complaint records 124 indicate that a complaining customer has numerous accounts with various segments of the enterprise (e.g., a checking account, a credit card account, and a home mortgage), the enterprise may wish to accelerate resolution of the complaint (as the customer may be viewed as “high value”). As another example, if aggregated complaint records 124 indicate that a complaining customer has also filed numerous other complaints across various segments of the enterprise, the enterprise may wish to accelerate resolution of the complaint.

Although a particular implementation of system 100 is illustrated and primarily described, the present disclosure contemplates any suitable implementation of system 100 according to particular needs. Although a particular number of components of system 100 have been illustrated and primarily described above, the present invention contemplates system 100 including any suitable number of such components. Furthermore, the various components of system 100 described above may be local or remote from one another. Additionally, the components of system 100 may be implemented in any suitable combination of hardware, firmware, and software.

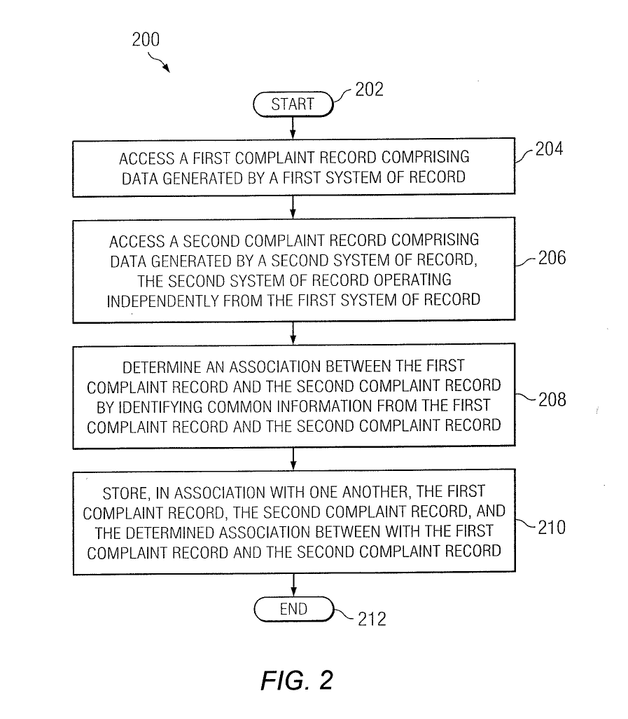

FIG. 2 illustrates an example method 200 for providing enterprise-wide complaint aggregation, according to certain embodiments of the present disclosure. The method begins at step 202. At step 204, aggregation system 104 accesses a first complaint record 114a comprising data generated by a first system of record 112a. At step 206, aggregation system 104 accesses a second complaint record 114b comprising data generated by a second system of record 112b, the second system of record 112b operating independently from the first system of record 112a. As described above, the first system of record 112a and the second system of record 112b may operate independently due to the fact that they are associated with different segments of an enterprise.

At step 208, aggregation system 104 determines an association between the first complaint record 114a and the second complaint record 114b by identifying common information from the first complaint record 114a and the second complaint record 114b. For example, the accessed first complaint record 114a may have been generated by a system of record 112a associated with a checking account department of an enterprise and may include categories of information including (1) the name of the complaining customer, (2) the checking account number of the complaining customer, and (3) a complaint type as defined within the checking account department. Additionally, the accessed second complaint record 114b may have been generated by a credit card department of the enterprise and may include categories of information including (1) the name of the complaining customer, (2) the credit card number of the complaining customer, and (3) a complaint type as defined within the credit card department. Aggregation system 104 may determine an association between complaint records 114a and 114b—complaint records 114a and 114b have a common category of information (i.e., the name of the complaining customer) and that the information contained in that category is the same (i.e., both complaint records 114 were generated in response to a complaint from the same customer).

At step 210, aggregation system 104 may store, in association with one another, the first complaint record, the second complaint record, and the determined association between with the first complaint record and the second complaint record as an aggregated complaint record 124.

Although the steps of method 200 have been described as being performed in a particular order, the present disclosure contemplates that the steps of method 200 may be performed in any suitable order, according to particular needs.

Although the present disclosure has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method, comprising:
accessing, by a processor, a first complaint record comprising data generated by a first system of record for an enterprise;
accessing, by the processor, a second complaint record comprising data generated by a second system of record for the enterprise, the second system of record operating independently from the first system of record;
determining, by the processor, an association between the first complaint record and the second complaint record by identifying common information from the first complaint record and the second complaint record;
generating, by the processor, an aggregated complaint record based on the determined association between the first complaint record and the second complaint record; and
storing, in a memory, the aggregated complaint record, wherein the aggregated complaint record comprises the first complaint record, the second complaint record, and the determined association between with the first complaint record and the second complaint record.

2. The method of claim 1, wherein the identified common information comprises a complaint type of the first complaint record and the second complaint record.

3. The method of claim 1, wherein:
the first complaint record is generated in response to a first complaint of a customer of the enterprise;
the second complaint record is generated in response to a second complaint of the customer of the enterprise; and
the identified common information comprises a customer identifier for the customer of the enterprise.

4. The method of claim 3, wherein the customer identifier comprises a social security number for the customer of the enterprise.

5. The method of claim 1, wherein:
the first complaint record is generated in response to a first complaint of a customer of the enterprise;
the second complaint record is generated in response to a second complaint of the customer of the enterprise; and
the identified common data comprises a household identifier for the customer of the enterprise.

6. The method of claim 5, wherein the household identifier comprises a home address for the customer of the enterprise.

7. The method of claim 1, further comprising:
accessing, by the processor, based on the determined association between the first complaint record and the second complaint, additional information corresponding to the first complaint record and the second complaint record;
storing, in the memory, the accessed additional information in the aggregated complaint record.

8. The method of claim 7, wherein:
the first complaint record is generated in response to a first complaint of a customer of the enterprise;
the second complaint record is generated in response to a second complaint of the customer of the enterprise;
the identified common data comprises a household identifier for the customer of the enterprise; and
the additional information comprises information associated with the household identifier not included in the first complaint record or the second complaint record.

9. The method of claim 1, wherein:
the first complaint record has a first complaint type;
the second complaint record has a second complaint type; and
the method further comprises:
determining, by the processor, based the first complaint type, a first complaint category for the first complaint record; and
determining, by the processor, based the second complaint type, a second complaint category for the first complaint record.

10. A system, comprising:
a memory operable to store complaint records generated by a plurality of systems of record for the enterprise; and
one or more processors communicatively coupled to the memory and operable to:
access a first complaint record comprising data generated by a first system of record for the enterprise;
access a second complaint record comprising data generated by a second system of record for the enterprise, the second system of record operating independently from the first system of record;
determine an association between the first complaint record and the second complaint record by identifying common information from the first complaint record and the second complaint record; and
generate an aggregated complaint record based on the determined association between the first complaint record and the second complaint record; and
the memory further operable to:
store the aggregated complaint record, wherein the aggregated complaint record comprises, the first complaint record, the second complaint record, and the determined association between with the first complaint record and the second complaint record.

11. The system of claim 10, wherein the identified common information comprises a complaint type of the first complaint record and the second complaint record.

12. The system of claim 10, wherein:
the first complaint record is generated in response to a first complaint of a customer of the enterprise;
the second complaint record is generated in response to a second complaint of the customer of the enterprise; and
the identified common information comprises a customer identifier for the customer of the enterprise.

13. The method of claim 12, wherein the customer identifier comprises a social security number for the customer of the enterprise.

14. The system of claim 10, wherein:
the first complaint record is generated in response to a first complaint of a customer of the enterprise;
the second complaint record is generated in response to a second complaint of the customer of the enterprise; and
the identified common data comprises a household identifier for the customer of the enterprise.

15. The system of claim 14, wherein the household identifier comprises a home address for the customer of the enterprise.

16. The system of claim 10, wherein the one or more processors are further operable to:
access, based on the determined association between the first complaint record and the second complaint, additional information corresponding to the first complaint record and the second complaint record; and
the memory is further operable to:
store the accessed additional information in the aggregated complaint record.

17. The system of claim 16, wherein:
the first complaint record is generated in response to a first complaint of a customer of the enterprise;
the second complaint record is generated in response to a second complaint of the customer of the enterprise;
the identified common data comprises a household identifier for the customer of the enterprise; and
the additional information comprises information associated with the household identifier not included in the first complaint record or the second complaint record.

18. The system of claim 10, wherein:
the first complaint record has a first complaint type;
the second complaint record has a second complaint type; and
the one or more processors are further operable to:
determine, based the first complaint type, a first complaint category for the first complaint record; and
determine, based the second complaint type, a second complaint category for the first complaint record.

19. A non-transitory computer-readable medium encoded with logic, the logic operable when executed to:
access a first complaint record comprising data generated by a first system of record for an enterprise;
access a second complaint record comprising data generated by a second system of record for the enterprise, the second system of record operating independently from the first system of record;
determine an association between the first complaint record and the second complaint record by identifying common information from the first complaint record and the second complaint record;
generate an aggregated complaint record based on the determined association between the first complaint record and the second complaint record; and
store the aggregated complaint record, wherein the aggregated complaint record comprises the first complaint record, the second complaint record, and the determined association between with the first complaint record and the second complaint record.

20. The computer-readable medium of claim 19, wherein the identified common information comprises a complaint type of the first complaint record and the second complaint record.

21. The computer-readable medium of claim 19, wherein:
the first complaint record is generated in response to a first complaint of a customer of the enterprise;
the second complaint record is generated in response to a second complaint of the customer of the enterprise; and
the identified common information comprises a customer identifier for the customer of the enterprise.

22. The computer-readable medium of claim 21, wherein the customer identifier comprises a social security number for the customer of the enterprise.

23. The computer-readable medium of claim 19, wherein:
the first complaint record is generated in response to a first complaint of a customer of the enterprise;
the second complaint record is generated in response to a second complaint of the customer of the enterprise; and
the identified common data comprises a household identifier for the customer of the enterprise.

24. The computer-readable medium of claim 23, wherein the household identifier comprises a home address for the customer of the enterprise.

25. The computer-readable medium of claim 19, wherein the logic is further operable when executed to:
access, based on the determined association between the first complaint record and the second complaint, additional information corresponding to the first complaint record and the second complaint record;
store the accessed additional information in the aggregated complaint record.

26. The computer-readable medium of claim 25, wherein:
the first complaint record is generated in response to a first complaint of a customer of the enterprise;
the second complaint record is generated in response to a second complaint of the customer of the enterprise;
the identified common data comprises a household identifier for the customer of the enterprise; and
the additional information comprises information associated with the household identifier not included in the first complaint record or the second complaint record.

27. The computer-readable medium of claim 19, wherein:
the first complaint record has a first complaint type;
the second complaint record has a second complaint type; and
the logic is further operable when executed to:
determine, based the first complaint type, a first complaint category for the first complaint record; and
determine, based the second complaint type, a second complaint category for the first complaint record.
